(19) United States
(12) Patent Application Publication
(10) Pub. No.: US 2013/0075967 A1
(43) Pub. Date: Mar. 28, 2013

(54) LIGHT WEIGHT PORTABLE TIRE STAND

(71) Applicant: MICHAEL CHRIS BARTON, THORNTON, CO (US)

(72) Inventor: MICHAEL CHRIS BARTON, THORNTON, CO (US)

(21) Appl. No.: 13/561,735

(22) Filed: Jul. 30, 2012

Related U.S. Application Data
(60) Provisional application No. 61/513,478, filed on Jul. 29, 2011.

(51) Int. Cl. B60C 25/00; B60B 30/08

(52) U.S. Cl. CPC B60C 25/00; B60B 30/08
USPC 269/52; 269/289 R

(57) ABSTRACT

Disclosed is a light weight, compact, portable stand designed to support a tire and wheel assembly at a comfortable working height while repairing a flat tire. It includes an apparatus with an adjustable attachment which will support a plurality of tire/wheel assemblies through the hub allowing the wheel to spin freely while secured to the stand. This prevents potential damage to spoke type wheels, Assembles and disassembles with a single attachment.

I claim priority to my provisional application No. 61/513,478 filed on Jul. 29, 2011

### BACKGROUND

The act of fixing a flat tire has always been a cumbersome process. Indeed, changing tires, whether automobile, motorcycle or bicycle fires has produced a significant amount of engineering around the types of holders for the vehicles, the wheels and or the tires in trying to aid in the process of changing tires.

One particular concern is the changing of motorcycle tires in that the wheels have spokes that can be damaged if not handled properly. Another issue surrounds the ability to change such tires in the field.

It is with respect to these and other aspects that the present invention has been made.

### SUMMARY

The present disclosure relates to a tire stand that is light in weight and portable. The tire stand comprises a tube section that has a threaded washer assembly attached to both ends. The upper section of the tube is adapted to receive a threaded washer assembly that also forms the base on which the wheel to be changed rests. The threaded washer is further adapted to receive a threaded rod. The threaded rod “holds” the wheel in place while repairing the flat tire. Lastly, a threaded handle, is screwed on to the threaded rod to secure the wheel onto the stand. The threaded washers are welded in place allowing the threaded rod to be screw in or out allowing for various types and thickness of the wheel. The threaded washers are also of different sizes to accommodate for variable sizes of wheels.

### BRIEF DESCRIPTION OF THE DRAWINGS

FIG. 1 is a plan view of the tire stand.

FIG. 2 is an exploded view of the tire stand showing the separate parts.

### DETAILED DESCRIPTION

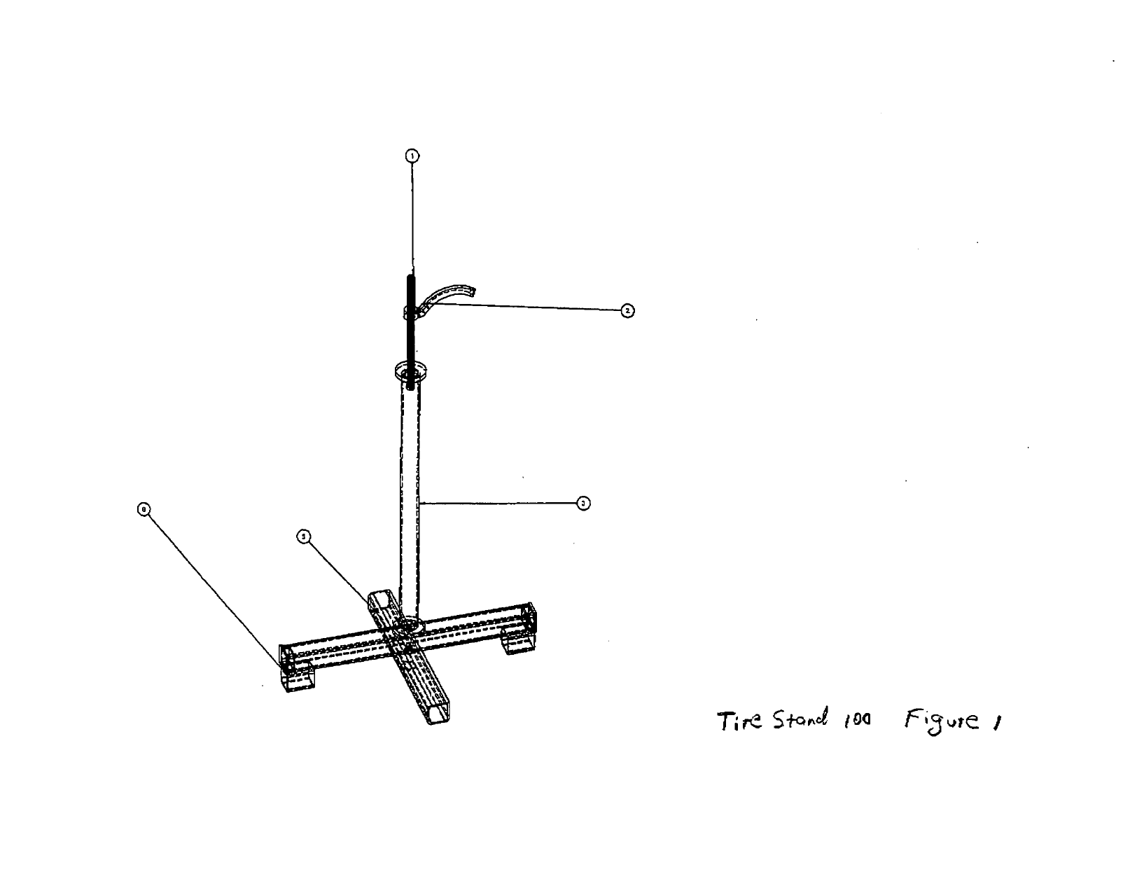

An embodiment of the present invention relates to a tire stand, such as tire stand 100 shown in FIG. 1. Tire stand 100 comprises a primary tube section and two leg sections. The two leg sections bolt together to the bottom of the primary tube section to create a sturdy base for the stand 100.

The stand 100 has a top platform piece that sits flat such that a wheel can rest on the platform. Additionally, a threaded rod is connected to the stand such that a wheel can easily be placed on the rod and rest on the platform. In a preferred embodiment, the rod is threaded such that a locking nut or securing mechanism (preferably having a handle) can be used to secure the wheel (not shown) into place.

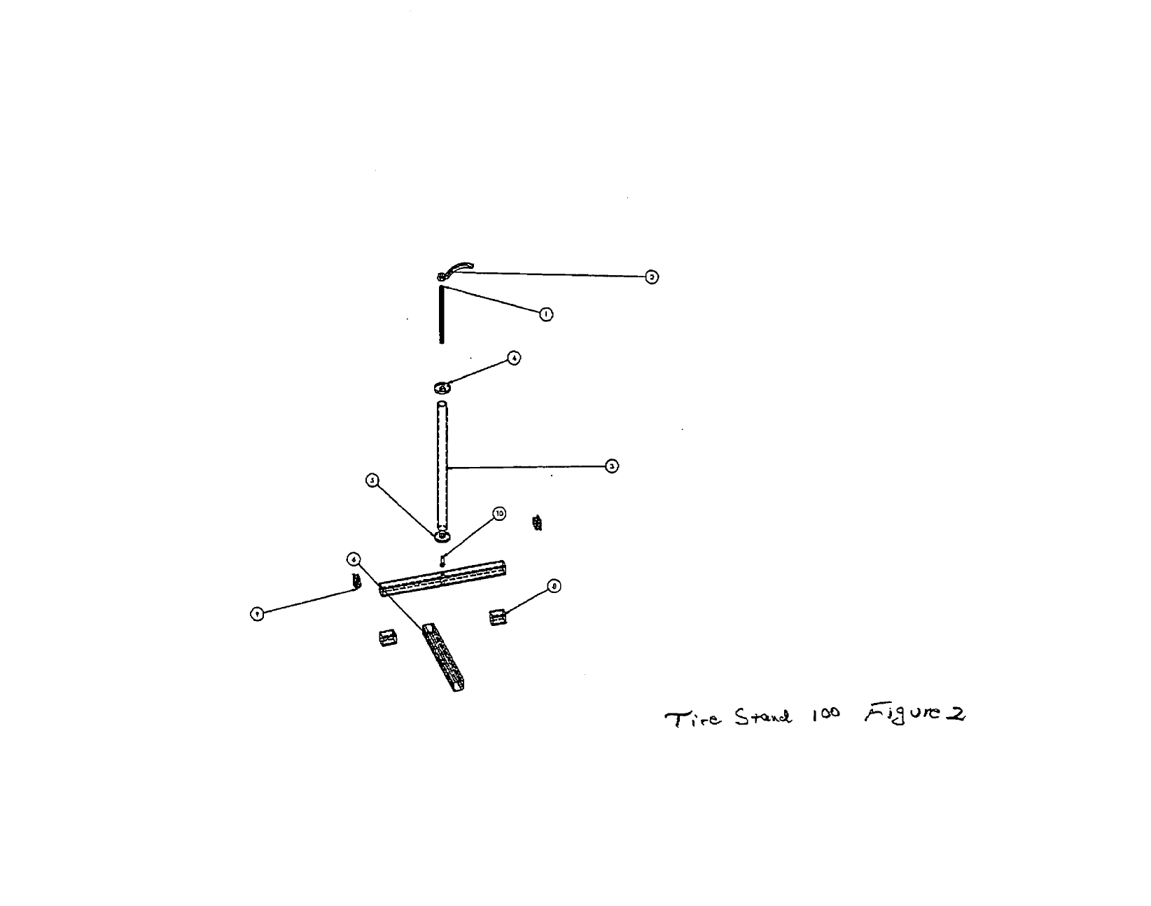

Stand 100 is shown in an exploded view in FIG. 2. The combination of the two square tube pieces form a base portion of the stand 100 having perpendicular sections. The base section connects to the tube section 100 with a single bolt which creates the working assembly. For ease of storage the base is designed so the sections can be rotated from perpendicular to parallel to minimize space required while the unit is not in use.

As shown in FIG. 2 the threaded washer assembly can be fabricated in different sizes to accommodate different sizes of wheels Also, in other embodiments, the platform piece may include a larger or smaller platform shown in FIG. 2. For instance, the tube may itself be formed with a flat portion on which the tire may rest, independent of the washer.

In an embodiment, the threaded washer fits into the tube in such a way as to allow the wheel, when attached to the rod to spin on the tube. In essence, the tube acts as a sleeve and the threaded washer could spin in the tube.

In other embodiments, the tube is constructed such that the rod piece slides within the tube a predetermined distance.

In an embodiment, the rod is a ⅝″×12″ threaded rod. In this particular embodiment, the top bolt of the tire stand is ⅝″ all-thread that can quickly be screwed in or out to adjust the height of the stand to accommodate a wheel that is being worked on. The handle of the stand can be tightened down against the wheel hub in the same fashion that you would tighten the axel nut on your car wheel.

Those skilled in the art will appreciate that the tube could be different shapes and still provide the same functionality. For example, the tube could be square shaped, as long as the threaded washer assembly could be attached to the top of the tube. Those skilled in the art will appreciate that the all-thread could be replaced by a stud or bolting mechanism with a nut for securement rather than a threaded handle. While sacrificing some flexibility or adjustability the embodiment would still function in the same manner Those skilled in the art will appreciate that the base and the lower tube section could be constructed so the tube section would slidably connect to the base rather than bolting.

In a preferred embodiment, the entire stand weighs less than 20 pounds. The stand also includes an all-thread and cast steel handle to secure a wheel in place and the bolt required to secure the base. It is also powdered coated for a longer lasting finish.

The tire stand secures the wheel by tightening the handle to the hub which allows the wheel to turn while secured to the stand. This, in turn, allows you to turn your wheel as you work avoiding the constant motion of walking around the wheel while fixing a flat. This also prevents damage to the wheel spokes.

Although the tire stand works well with motorcycle wheels given smaller platform piece (which prevents damage to the spokes), it can also be adapted for use with other wheels, e.g., bicycle and/or automobile wheels, ATV wheels or lawn and garden.

In other embodiments all of the components could be constructed from different materials such as ferrous and non-ferrous metals or composites in different structural shapes and sizes where a base assembly supports an upright section that could support a tire and wheel by resting it on a top platform and securing the assembly by using a single all-thread or bolt, or stud, through the hub and bearings in such a way to allow the tire to spin freely while repairing a flat tire

This disclosure describes some embodiments with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

1. A Tire Stand comprising:
A tube having an upper portion and lower portion, the upper tube portion having the ability to attach a tire and wheel assembly with a single threaded attachment to the top and a lower portion having the ability to attach a base section substantial enough to support a tire and wheel;

2. A plurality of leg portions that attach to the lower tube portion using a single attachment;

3. A threaded rod piece for positioning partly within the upper portion of the tube with the ability to adjust height for variable wheel/hub thickness;

4. A threaded piece is attached to the upper portion of the tube creating a platform to support the tire and wheel assembly;

5. A securing mechanism that secures the wheel to the top tube portion through the wheel/hub such that the wheel spins freely while secured on the tube.
